(19) United States
(12) Patent Application Publication
(10) Pub. No.: US 2018/0030343 A1
(43) Pub. Date: Feb. 1, 2018

(54) PREPARATION METHOD OF QUANTUM DOT COMPOUND SPHERES COATED WITH GRAPHENESAND QUANTUM DOT COMPOUND SPHERES COATED WITH GRAPHENES

(71) Applicant: Shenzhen China Star Optoelectronics Technology Co., Ltd., Shenzhen City (CN)

(72) Inventor: Tao Hu, Shenzhen City (CN)

(21) Appl. No.: 14/912,608

(22) PCT Filed: Dec. 23, 2015
(86) PCT No.: PCT/CN2015/098513

§ 371 Date: Feb. 18, 2016

(30) Foreign Application Priority Data
Nov. 16, 2015 (CN) 201510790980.4

(51) Int. Cl. C09K 11/65; B82Y 40/00; C09K 11/02

(52) U.S. Cl. CPC C09K 11/65; C09K 11/02; B82Y 40/00

(57) ABSTRACT

The present disclosure provides a preparation method of quantum dot compound spheres coated with graphenes and quantum dot compound spheres coated with graphenes. Prepared quantum dot compound spheres coated with graphenes according to the preparation method of quantum dot compound spheres coated with graphenes of the disclosure have dispersion stability, the preparation method is easily processed; quantum dots are protected by water and oxygen proofed graphenes, and dispersity of quantum dots in materials like glue or light resistance materials can be improved by hydrophobicity of graphenes, so that the quantum dot compound spheres coated with graphenes do well in dispersion stability, which can be produced to be quantum dot films, the preparation process of a quantum dot film is simplified.

### FIELD OF THE INVENTION

The present invention relates to a display technology field, and more particularly to a preparation method of quantum dot compound spheres coated with graphenes and quantum dot compound spheres coated with graphenes.

### BACKGROUND OF THE INVENTION

With the development of the display technology, much emphasis has been laid upon display quality of a display device. Color gamut of a liquid crystal television on the market is between 68%-72% national television standards committee (TNSC), hence high qualified color effects cannot be satisfied. High color gamut backlight technology is achieving more attention in the field for improving color gamut of a liquid crystal television.

Quantum dots (QDs) are semiconductor particles with sizes between 1 to 100 nm. As particle sizes of QDs are smaller than or close to Bohr radius of exciton of the corresponding bulk material and the quantum confinement effect occurs, a successive band structure of the bulk material can be transformed in a separated band structure, and electrons can be stimulated to transition by the external light so as to emit fluorescence.

The sort of special separated band structure leads to a narrow half wave width, so the emitted single color can be high purity, resulting in a quantum dot display has higher efficiency compared with a conventional display. Meanwhile, since energy level gaps of QDs are significantly influenced by sizes, lights with different wavelengths can be stimulated by manipulating sizes of QDs or applying QDs with various components. A quantum dot film of lit by emitting added into a backlight structure to meet the requirements of wide color gamut and high color saturation in a display has become a preferred choice of display manufacturers, however, the widely applied backlight reinforced quantum dot films are pricy, and separated QDs films increase the thickness of the display module, resisting the trend of lightening and thinning. Therefore, QDs are combined with each layer structure on a polarized plate to produce a polarized plate with QDs, or QDs are combined with color resistance materials to form color filter layers, which can not only reduce costs of separately preparing quantum dot film, but also efficiently reduce the thickness of the whole module. However, QDs are sensitive to the environment, especially water and oxygen, which can easily affect light emitting efficiency and lifetime. Glues can be applied to coat QDs to avoid the influence from outside, an insulating layer is coated on surfaces of QDs to protect QDs. However, the difficulty appears in selecting an appropriate glue with the suitable viscosity, which can cover QDs and disperse homogeneously in a color resistance solvent.

### SUMMARY OF THE INVENTION

The objective of the disclosure is to provide a preparation method of quantum dot compound spheres coated with graphenes, quantum dots are coated with graphenes to achieve dispersion stability, and the preparation method is easily processed.

The present disclosure further provides a quantum dot compound sphere coated with graphenes, quantum dots are coated with graphenes that can isolate water and oxygen to insulate influence from outside, and as surfaces of graphenes are water-proof, the quantum dots are coated with graphenes have a property of dispersion stability, which can be produced to be quantum dot films, the preparation process of a quantum dot film is simplified.

To achieve the objective above, the disclosure provides a preparation method of quantum dot compound spheres coated with graphenes, including following steps:

step 1, mixing and stirring stoichiometric quantum dots and a graphene solution to prepare a mixed solution that is homogeneous;

step 2, pouring the mixed solution into a centrifuge tube to centrifugalize in a centrifuge;

step 3, throwing out the supernatant after centrifugalization, taking out and drying precipitate on bottom of the centrifuge tube, achieving quantum dot compound spheres coated with graphenes.

Graphenes in the graphene solution are nano-sized graphene plates, number of layers of the nano-sized graphene plates is 1˜3.

The quantum dots are oil-soluble quantum dots, a solvent of the graphene solution is an organic solvent.

The organic solvent is ethanol, N-methyl pyrrolidone, or dimethyl form amide.

The quantum dots are water-soluble quantum dots, a solvent of the graphene solution is water.

The quantum dots include one or more of the following doped or non-doped quantum dots: zinc sulfide, cadmium sulfide, zinc oxide, gallium nitride, gallium selenide, zinc selenide, cadmium selenide, zinc telluride, cadmium telluride, lead telluride, indium phosphide, and gallium arsenide.

The quantum dots include one or more of graphene quantum dots and carbon quantum dots.

In the step 1, concentration of the graphene solution is 0.01 mg/ml˜2 mg/ml, the quantum dots and the graphene solution are mixed based on stoichiometry of graphenes and quantum dots is 1:10˜1:100, time for stirring is 5 min˜120 min.

In the step 2, the mixed solution is centrifugalized at a rotational speed of 2000 rpm˜8000 rpm, time for centrifugalization is 1 min˜60 min; in the step 3, drying temperature is 80° C.˜120° C., drying time is 10 min˜60 min.

The disclosure further provides a quantum dot compound sphere coated with graphenes, including an outer layer graphenes, and a quantum dot coated with graphenes, the graphenes are nano-sized graphene plates, number of layers of the nano-sized graphene plates is 1˜3.

The disclosure further provides a preparation method of quantum dot compound spheres coated with graphenes, including following steps:

step 1, mixing and stirring stoichiometric quantum dots and a graphene solution to prepare a mixed solution that is homogeneous;

step 2, pouring the mixed solution into a centrifuge tube to centrifugalize in a centrifuge;

step 3, throwing out the supernatant after centrifugalization, taking out and drying precipitate on bottom of the centrifuge tube, achieving quantum dot compound spheres coated with graphenes;

Graphenes in the graphene solution are nano-sized graphene plates, number of layers of the nano-sized graphene plates is 1˜3; in the step 1, concentration of the graphene solution is 0.01 mg/ml˜2 mg/ml, the quantum dots and the graphene solution are mixed based on stoichiometry of graphenes and quantum dots is 1:10˜1:100, time for stirring is 5 min˜120 min; in the step 2, the mixed solution is centrifugalized at a rotational speed of 2000 rpm˜8000 rpm, time for centrifugalization is 1 min˜60 min; in the step 3, drying temperature is 80° C.˜120° C., drying time is 10 min˜60 min.

Advantages of the disclosure: the disclosure provides a preparation method of quantum dot compound spheres coated with graphenes and quantum dot compound spheres coated with graphenes. Prepared quantum dot compound spheres coated with graphenes according to the preparation method of quantum dot compound spheres coated with graphenes of the disclosure have dispersion stability, the preparation method is easily processed; according to quantum dot compound spheres coated with graphenes of the disclosure, quantum dots are protected by water and oxygen proofed graphenes, and dispersity of quantum dots in materials like glue or light resistance materials can be improved by hydrophobicity of graphenes, so that the quantum dot compound spheres coated with graphenes do well in dispersion stability, which can be produced to be quantum dot films, the preparation process of a quantum dot film is simplified.

In order to better understand features and proposals of the present disclosure, the following detailed illustration and figures can be referred, it is obvious that the drawings are merely for reference and explanation, which do not limit the scope of the present invention.

### BRIEF DESCRIPTION OF THE DRAWINGS

In order to more clearly illustrate the embodiments and advantages of the present disclosure, the following figures described in the embodiments are introduced.

FIG. 1 is a flow chart of a preparation method of quantum dot compound spheres coated with graphenes of the present disclosure.

### DETAILED DESCRIPTION OF PREFERRED EMBODIMENTS

Technical matters and achieved objects of the present disclosure are described in detail with the embodiments and the accompanying drawing for better understanding.

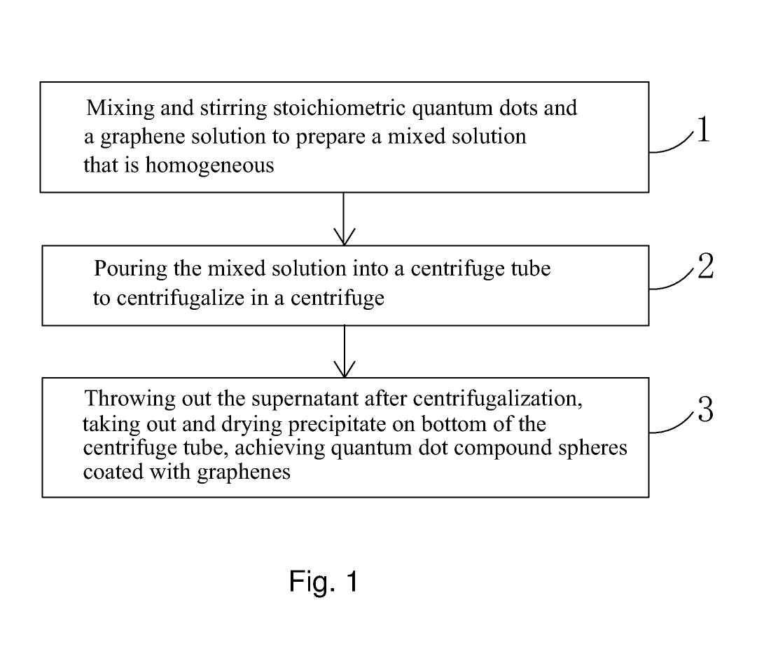

Referring to FIG. 1, the disclosure provides a preparation method of quantum dot compound spheres coated with graphenes, including following steps:

step 1, mixing and stirring stoichiometric quantum dots and a graphene solution to prepare a mixed solution that is homogeneous;

Specifically, considering light transmittance of graphenes, graphenes in the graphene solution are 1˜3 layers of nano-sized graphene plates to prevent influence on quantum dot compound spheres coated with graphenes in light.

Specifically,when the quantum dots are oil-soluble quantum dots, a solvent of the graphene solution is an organic solvent; preferably, the organic solvent is ethanol, N-methyl pyrrolidone (NMP), or dimethyl formamide (DMF); when the quantum dots are water-soluble quantum dots, a solvent of the graphene solution is water.

Specifically, the quantum dots can include one or more of the following doped or non-doped quantum dots: zinc sulfide, cadmium sulfide, zinc oxide, gallium nitride, gallium selenide, zinc selenide, cadmium selenide, zinc telluride, cadmium telluride, lead telluride, indium phosphide, and gallium arsenide. The quantum dots can also include graphene quantum dots and carbon quantum dots, etc.

Specifically, concentration of the graphene solution is 0.01 mg/ml˜2 mg/ml, the quantum dots and the graphene solution are mixed based on stoichiometry of graphenes and quantum dots is 1:10˜1:100, time for stirring is 5 min˜120 min.

Step 2, pouring the mixed solution into a centrifuge tube to centrifugalize in a centrifuge at a rotational speed of 2000 rpm˜8000 rpm for 1 min˜60 min.

Step 3, throwing out the supernatant after centrifugalization, taking out precipitate on bottom of the centrifuge tube and drying it at 80° C.˜120° C. for 10 min˜60 min, achieving quantum dot compound spheres coated with graphenes;

Based on the preparation method above, the disclosure further provides a quantum dot compound sphere coated with graphenes, including an outer layer graphenes, and a quantum dot coated with graphenes, the graphenes are nano-sized graphene plates, number of layers of the nano-sized graphene plates is 1˜3.

Specifically, the quantum dots can include one or more of the following doped or non-doped quantum dots: zinc sulfide, cadmium sulfide, zinc oxide, gallium nitride, gallium selenide, zinc selenide, cadmium selenide, zinc telluride, cadmium telluride, lead telluride, indium phosphide, and gallium arsenide; the quantum dots can also include graphene quantum dots and carbon quantum dots, etc.

The quantum dots coated with graphenes can be mixed with glue, solvents, color block materials or other materials to prepare quantum dot films, the quantum dot films are applied in a backlight structure, a polarized plate, or a color filter plate of a display device for enhancing color gamut and color saturation of a display device.

The quantum dots coated with graphenes according to the disclosure employ soft 1˜3 layers of quantum dots coated with graphenes, when large sized graphene nano plates coat quantum dots, overlapped graphene nano plates can form a tight seal like a sack due to van der waals forces among carbon atoms on surfaces of graphenes and properties of block water and oxygen of graphenes, quantum dots are sealed and protected; and graphenes are inorganic, the surfaces are impervious to water, which can be dispersed in other materials such as glue and light block materials without influencing performance of glue and light block materials, resulting in improve dispersity of quantum dots, therefore, quantum dot compound spheres coated with graphenes can be easily dispersed in materials like solvents, glue and light block materials to form quantum dot films, which can simplify the preparation process of a conventional quantum dot film.

Preferred embodiments of the preparation method of quantum dot compound spheres coated with graphenes are as follows:

### Embodiment 1

Dispersing graphenes in organic solvent NMP to achieve a graphene solution (concentration is 0.01 mg/ml), combined with oil-soluble quantum dots (stoichiometry of graphenes: quantum dots=1:10), stirring for 5 min to be homogeneity, centrifugalizing at 2000 rpm for 60 min, taking out precipitate on bottom of the centrifuge tube, drying at 80° C. for 10 min to achieve quantum dot compound spheres coated with graphenes.

### Embodiment 2

Dispersing graphenes in organic solvent NMP to achieve a graphene solution (concentration is 2 mg/ml), combined with oil-soluble quantum dots (stoichiometry of graphenes: quantum dots=1:50), stirring for 120min to be homogeneity, centrifugalizing at 8000 rpm for 1 min, taking out precipitate on bottom of the centrifuge tube, drying at 120° C. for 10 min to achieve quantum dot compound spheres coated with graphenes.

### Embodiment 3

Dispersing graphenes in organic solvent DMF to achieve a graphene solution (concentration is 1 mg/ml), combined with oil-soluble quantum dots (stoichiometry of graphenes: quantum dots=1:100), stirring for 60 min to be homogeneity, centrifugalizing at 5000 rpm for 30 min, taking out precipitate on bottom of the centrifuge tube, drying at 100° C. for 60 min to achieve quantum dot compound spheres coated with graphenes.

### Embodiment 4:

Dispersing graphenes in organic solvent ethanol to achieve a graphene solution (concentration is 0.8 mg/ml), combined with oil-soluble quantum dots (stoichiometry of graphenes: quantum dots=1:30), stirring for 100 min to be homogeneity, centrifugalizing at 6000 rpm for 20 min, taking out precipitate on bottom of the centrifuge tube, drying at 100° C. for 30 min to achieve quantum dot compound spheres coated with graphenes.

### Embodiment 5

Combining graphenes solution (concentration is 0.01 mg/ml) with water-soluble quantum dots (stoichiometry of graphenes: quantum dots=1:100), stirring for 10 min to be homogeneity, centrifugalizing at 4000 rpm for 50 min, taking out precipitate on bottom of the centrifuge tube, drying at 80° C. for 60 min to achieve quantum dot compound spheres coated with graphenes.

### Embodiment 6

Combining graphenes solution (concentration is 0.5 mg/ml) with water-soluble quantum dots (stoichiometry of graphenes: quantum dots=1:50), stirring for 5 min to be homogeneity, centrifugalizing at 2000 rpm for 60 min, taking out precipitate on bottom of the centrifuge tube, drying at 120° C. for 10 min to achieve quantum dot compound spheres coated with graphenes.

### Embodiment 7

Combining graphenes solution (concentration is 2 mg/ml) with water-soluble quantum dots (stoichiometry of graphenes: quantum dots=1:10), stirring for 120 min to be homogeneity, centrifugalizing at 8000 rpm for 1 min, taking out precipitate on bottom of the centrifuge tube, drying at 120° C. for 30 min to achieve quantum dot compound spheres coated with graphenes.

### Embodiment 8

Combining graphenes solution (concentration is 1 mg/ml) with water-soluble quantum dots (stoichiometry of graphenes: quantum dots=1:30), stirring for 60 min to be homogeneity, centrifugalizing at 6000 rpm for 30 min, taking out precipitate on bottom of the centrifuge tube, drying at 100° C. for 60 min to achieve quantum dot compound spheres coated with graphenes.

Overall, the prepared quantum dot compound spheres coated with graphenes according to the preparation method of quantum dot compound spheres coated with graphenes of the disclosure have dispersion stability, the preparation method is easily processed;quantum dots are protected by water and oxygen proofed graphenes, and dispersity of quantum dots in materials like glue or light resistance materials can be improved by hydrophobicity of graphenes, so that the quantum dot compound spheres coated with graphenes do well in dispersion stability, which can be produced to be quantum dot films, the preparation process of a quantum dot film is simplified.

Above are embodiments of the present invention, which does not limit the scope of the present invention. Any modifications, equivalent replacements or improvements within the spirit and principles of the embodiment described above should be covered by the protected scope of the invention.

What is claimed is:

1. A preparation method of quantum dot compound spheres coated with graphenes, comprising following steps:
step 1, mixing and stirring stoichiometric quantum dots and a graphene solution to prepare a mixed solution that is homogeneous;
step 2, pouring the mixed solution into a centrifuge tube to centrifugalize in a centrifuge;
step 3, throwing out supernatant after centrifugalization, taking out and drying precipitate on bottom of the centrifuge tube, achieving quantum dot compound spheres coated with graphenes.

2. The preparation method of quantum dot compound spheres coated with graphenes according to claim 1, wherein graphenes in the graphene solution are nano-sized graphene plates, number of layers of the nano-sized graphene plates is 1˜3.

3. The preparation method of quantum dot compound spheres coated with graphenes according to claim 1, wherein the quantum dots are oil-soluble quantum dots, a solvent of the graphene solution is an organic solvent.

4. The preparation method of quantum dot compound spheres coated with graphenes according to claim 3, wherein the organic solvent is ethanol, N-methyl pyrrolidone, or dimethyl formamide.

5. The preparation method of quantum dot compound spheres coated with graphenes according to claim 1, wherein the quantum dots are water-soluble quantum dots, a solvent of the graphene solution is water.

6. The preparation method of quantum dot compound spheres coated with graphenes according to claim 1, wherein the quantum dots comprise one or more of the following doped or non-doped quantum dots: zinc sulfide, cadmium sulfide, zinc oxide, gallium nitride, gallium selenide, zinc selenide, cadmium selenide, zinc telluride, cadmium telluride, lead telluride, indium phosphide, and gallium arsenide.

7. The preparation method of quantum dot compound spheres coated with graphenes according to claim 1, wherein the quantum dots comprise one or more of graphene quantum dots and carbon quantum dots.

8. The preparation method of quantum dot compound spheres coated with graphenes according to claim 1, wherein in the step 1, concentration of the graphene solution is 0.01 mg/ml˜2 mg/ml, the quantum dots and the graphene solution are mixed based on stoichiometry of graphenes and quantum dots that is 1:10˜1:100, time for stirring is 5 min˜120 min.

9. The preparation method of quantum dot compound spheres coated with graphenes according to claim 1, wherein in the step 2, the mixed solution is centrifugalized at a rotational speed of 2000 rpm˜8000 rpm, time for centrifugalization is 1 min˜60 min; in the step 3, drying temperature is 80° C.˜120° C., drying time is 10 min˜60 min.

10. A quantum dot compound sphere coated with graphenes, comprising an outer layer graphenes, and a quantum dot coated with graphenes, wherein the graphenes are nano-sized graphene plates, number of layers of the nano-sized graphene plates is 1˜3.

11. A preparation method of quantum dot compound spheres coated with graphenes, comprising following steps:
step 1, mixing and stirring stoichiometric quantum dots and a graphene solution to prepare a mixed solution that is homogeneous;
step 2, pouring the mixed solution into a centrifuge tube to centrifugalize in a centrifuge;
step 3, throwing out the supernatant after centrifugalization, taking out and drying precipitate on bottom of the centrifuge tube, achieving quantum dot compound spheres coated with graphenes;
wherein graphenes in the graphene solution are nano-sized graphene plates, number of layers of the nano-sized graphene plates is 1˜3;
wherein in the step 1, concentration of the graphene solution is 0.01 mg/ml˜2 mg/ml, the quantum dots and the graphene solution are mixed based on stoichiometry of graphenes and quantum dots that is 1:10˜1:100, time for stirring is 5 min˜120 min;
wherein in the step 2, the mixed solution is centrifugalized at a rotational speed of 2000 rpm˜8000 rpm, time for centrifugalization is 1 min˜60 min; in the step 3, drying temperature is 80° C.˜120° C., drying time is 10 min˜60 min.

12. The preparation method of quantum dot compound spheres coated with graphenes according to claim 11, wherein the quantum dots are oil-soluble quantum dots, a solvent of the graphene solution is an organic solvent.

13. The preparation method of quantum dot compound spheres coated with graphenes according to claim 12, wherein the organic solvent is ethanol, N-methyl pyrrolidone, or dimethyl formamide.

14. The preparation method of quantum dot compound spheres coated with graphenes according to claim 11, wherein the quantum dots are water-soluble quantum dots, a solvent of the graphene solution is water.

15. The preparation method of quantum dot compound spheres coated with graphenes according to claim 11, wherein the quantum dots comprise one or more of the following doped or non-doped quantum dots: zinc sulfide, cadmium sulfide, zinc oxide, gallium nitride, gallium selenide, zinc selenide, cadmium selenide, zinc telluride, cadmium telluride, lead telluride, indium phosphide, and gallium arsenide.

16. The preparation method of quantum dot compound spheres coated with graphenes according to claim 11, wherein the quantum dots comprise one or more of graphene quantum dots and carbon quantum dots.
